(19) United States
(12) Patent Application Publication
(10) Pub. No.: US 2005/0105563 A1
(43) Pub. Date: May 19, 2005

(54) Multi-channel statistical multiplexing system

(75) Inventors: Tadashi Suzuki, Tokyo (JP); Motoyuki Inaba, Tokyo (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/975,948

(22) Filed: Oct. 29, 2004

(30) Foreign Application Priority Data
Nov. 14, 2003 (JP) 2003-384834

(51) Int. Cl. H04J 3/22; H04J 3/16

(52) U.S. Cl. 370/535; 370/468

(57) ABSTRACT

A multi-channel statistical multiplexing system which includes a plurality of statistical multiplexing units each for encoding a plurality of channels of video data and then mutiplexing the encoded data to generate mutiplexed data, and a multiplexing unit for further multiplexing the multiplexed data from the plurality of statistical multiplexing units.

### BACKGROUND OF THE INVENTION

1. Field of the Invention

The present invention relates to a multi-channel statistical multiplexing system.

2. Description of the Related Background Art

For TV broadcasting systems, such as satellite or CATV broadcasting systems, with a transmission line of approximately 30 Mbps, it was possible to multiplex and deliver only about seven channels of video streams at most, for example, according to the conventional MPEG-2 scheme (video compression standards for digital video broadcasting). On the other hand, there is also a method available for use with multiplexing video streams, known as a statistical multiplexing method (e.g., see Japanese Patent Application Kokai No. 2000-41250). This method enables statistical multiplexing of a plurality of video streams, allowing the system to provide video images of uniform quality and thereby improved total quality. However, most methods of this type are adapted to multiplex about 10 channels of video streams at most duo to the size of hardware and the control operation for the statistical multiplexing.

Using a recent highly efficient encoding method to encode and then multiplex video streams, it is also possible to multiplex more than 15 channels of video streams into a 30 Mbps transmission line. However, adaptive processing for multiplexing such multiple channels of video streams using only one unit would cause a significant increase in hardware size of the unit itself and make its configuration more complicated, thereby making the mutiplexing operation difficult in terms of speeds.

### SUMMARY OF THE INVENTION

An object of the present invention is to provide a multi-channel statistical multiplexing system that enables efficient multiplexing of multiple channels of video streams without making the structure of the system complicated.

A multi-channel statistical multiplexing system according to the present invention is characterized by comprising a plurality of statistical multiplexing units each of which encodes a plurality of channels of video data and then multiplexes the encoded data to generate multiplexed data, and a multiplexing unit for further multiplexing the multiplexed data from the plurality of statistical multiplexing units.

A multi-channel statistical multiplexing method according to the present invention is characterized by comprising a plurality of statistical multiplexing steps each for encoding a plurality of channels of video data and then multiplexing the encoded data to generate multiplexed data, and a multiplexing step for further multiplexing the multiplexed data generated through the plurality of statistical multiplexing steps.

### BRIEF DESCRIPTION OF THE DRAWINGS

FIG. 1 is a block diagram showing an embodiment of the present invention;

FIG. 2 is a block diagram showing the configuration of a statistical multiplexing unit;

FIG. 3 is a flowchart showing the operation of a multiplexing unit;

FIG. 4 is a view showing how bit rates are assigned to each TS packet;

FIG. 5 is a view showing a transmission data structure used for transmission of multiplexed data, statistical multiplexing status information, and allocated bandwidth information along the same transmission line;

FIG. 6 is a block diagram showing another embodiment of the present invention; and

FIG. 7 is a block diagram showing still another embodiment of the present invention.

### DETAILED DESCRIPTION OF THE INVENTION

Now, embodiments of the present invention will be described below in more detail with reference to the accompanying drawings.

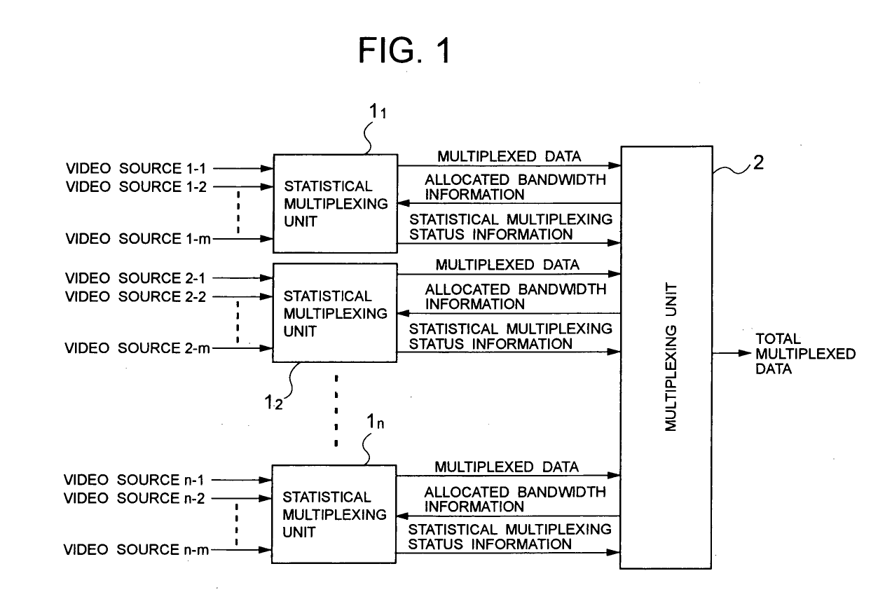

FIG. 1 shows a multi-channel statistical multiplexing system according to the present invention. This multi-channel statistical multiplexing system includes a plurality of statistical multiplexing units 1₁-1ₙ and a multiplexing unit 2. Each of the plurality of statistical multiplexing units 1₁-1ₙ and the multiplexing unit 2 may be located seperately from each other.

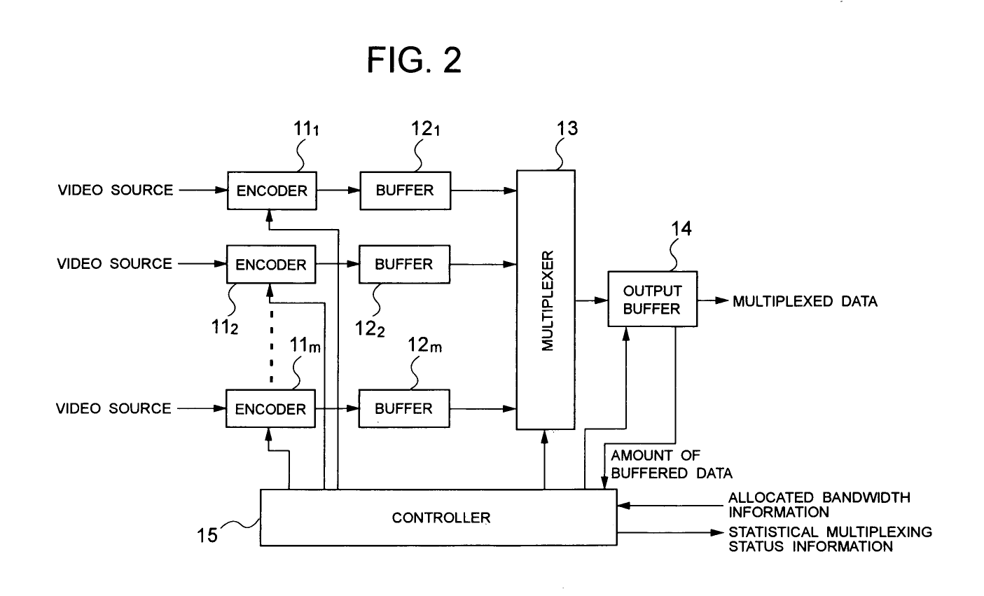

All the plurality of statistical multiplexing units 1₁-1ₙ are of the same configuration. For example, such a statistical multiplexing unit as used here may be one disclosed in Japanese Patent Application Kokai No. 2000-41250. More specifically, as shown in FIG. 2, each of the plurality of statistical multiplexing units 1₁-1ₙ with video source inputs for m channels has at least a fundamental configuration that includes encoders 11₁-11ₘ and buffers 12₁-12ₘ for m channels, a multiplexer 13, an output buffer 14, and a controller 15. As used herein, the term “channel” refers to a path along which image data is sent from each video source.

Each of the encoders 11₁-11ₘ for m channels encodes video data from input video sources according to the MPEG-2 scheme for delivery to the multiplexer 13 via the buffers 12₁-12ₘ each corresponding to the respective channels. Here, it is also possible to employ other encoding methods. The multiplexer 13 then multiplexes the m channels of encoded data. The output buffer 14 holds the multiplexed data delivered from the multiplexer 13. The controller 15 controls the amount of codes in the encoders 11₁-11ₘ, the multiplexing operation by the multiplexer 13, and the buffering operation by the output buffer 14.

Each of the plurality of statistical multiplexing units 1₁-1ₙ is connected to the multiplexing unit 2. Between each of the plurality of statistical multiplexing units 1₁-1ₙ and the multiplexing unit 2, an output signal from the output buffer 14 of each of the plurality of statistical multiplexing units 1₁-1ₙ or multiplexed data is supplied to the multiplexing unit 2. Each of the plurality of statistical multiplexing units 1₁-1ₙ also supplies information about its statistical multiplexing status to the multiplexing unit 2. From the multiplexing unit 2, on the other hand, information on an allocated bandwidth is supplied to each of the plurality of statistical multiplexing units 1₁-1ₙ. The statistical multiplexing status information includes information on the effective output rate and the amount of data in the output buffer (filling factors) of each of the statistical multiplexing units 1₁-1ₙ. The statistical multiplexing status information may also include an offset time with respect to a reference delivery time. The allocated bandwidth information indicates bit rates (the amount of codes per unit time) to be allocated to each of the statistical multiplexing units 1₁-1ₙ by the multiplexing unit 2.

It is also possible to share the same transmission line for bi-directional transmission of the statistical multiplexing status information and the allocated bandwidth information between each of the statistical multiplexing units 1₁-1ₙ and the multiplexing unit 2.

The multiplexing unit 2 further multiplexes the multiplexed data from each of the statistical multiplexing units 1₁-1ₙ to output the resulting total multiplexed data into the transmission line. The multiplexing unit 2 reads the statistical multiplexing status information from each of the statistical multiplexing units 1₁-1ₙ for monitoring, and then delivers the aforementioned allocated bandwidth information to each of the statistical multiplexing units 1₁-1ₙ in accordance with statistical multiplexing status information from each of the statistical multiplexing units 1₁-1ₙ, so that the bit rate of the total multiplexed data falls within the bandwidth of the transmission line.

In the multi-channel statistical multiplexing system configured as such, the multiplexing unit 2 initially supplies a predefined reference bit rate as the allocated bandwidth information to each of the statistical multiplexing units 1₁-1ₙ. In each of the statistical multiplexing units 1₁-1ₙ, this initial operation by the multiplexing unit 2 allows the controller 15 to control the amount of codes in each of the encoders 11₁-11ₘ and the output bit rate of the multiplexer 13 in accordance with the reference bit rate indicated by the allocated bandwidth information supplied.

The reference bit rate may be the same for the statistical multiplexing units 1₁-1ₙ or defined for each of the statistical multiplexing units 1₁-1ₙ. The sum of the reference bit rates for the statistical multiplexing units 1₁-1ₙ is the bit rate of the total output multiplexed data from the multiplexing unit 2 and a bit rate within the bandwidth of the transmission line as well.

After having assigned the reference bit rate, the multiplexing unit 2 sets the bit rate of each of the statistical multiplexing units 1₁-1ₙ at predetermined time intervals. The predetermined time interval is, for example, the period for one frame of video signals.

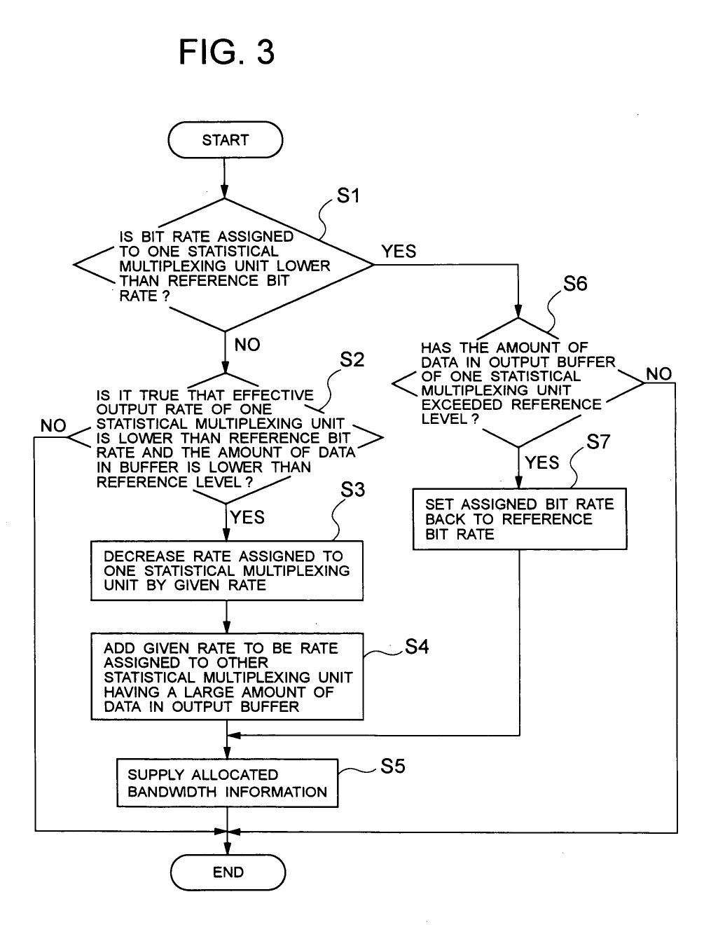

Now, a description is made to how to set a bit rate to one of the statistical multiplexing units 1₁-1ₙ. As shown in FIG. 3, the multiplexing unit 2 determines whether the current rate assigned to the one statistical multiplexing unit has been set to be lower than the reference bit rate (Step S1). If the rate assigned to the one statistical multiplexing unit has the same setting as the initial one, then the multiplexing unit 2 reads the statistical multiplexing status information on the one statistical multiplexing unit to determine whether the effective output rate of the one statistical multiplexing unit is lower than the reference bit rate assigned to the one statistical multiplexing unit and whether the amount of data in the output buffer 14 of the one statistical multiplexing unit is less than a given reference level, in accordance with the statistical multiplexing status information read (Step S2). If “yes” in Step S2, then the bit rate assigned to the one statistical multiplexing unit is set to be lower than the reference bit rate (Step S3). The difference with respect to the reference value is added to the reference bit rate assigned to a statistical multiplexing unit having a larger amount of output buffering among the other statistical multiplexing units (Step S4).

The allocated bandwidth information indicating the assigned bit rate is supplied to the statistical multiplexing unit to which a change in assigned bit rate has been made in this manner (Step S5).

If the assigned bit rate is found to be lower than the reference bit rate in Step S1, then the multiplexing unit 2 determines whether the amount of data in the output buffer 14 of the one statistical multiplexing unit is above the reference level (Step S6). If “yes” in S6, the process sets the assigned bit rate back to the original reference bit rate (Step S7) and proceeds to Step S5 to supply its allocated bandwidth information.

For example, in Step S3, a bit rate ALRx assigned to the one statistical multiplexing unit is decreased by a given rate ΔR. That is, ALRx=IALRx−ΔR, where IALRx is the reference bit rate assigned to the one statistical multiplexing unit as an initial value. In Step S4, a bit rate ALRy assigned to a statistical multiplexing unit having a large amount of data in the output buffer is increased by a given rate ΔR. That is, ALRy=IALRy+ΔR, where IALRy is the reference bit rate assigned to that statistical multiplexing unit as an initial value.

In Step S7, the process sets them such that ALRx=IALRx or ALRy=IALRy.

This setting operation of bit rates is also performed in the same manner on each of the other statistical multiplexing units other than the one statistical multiplexing unit.

Accordingly, the controller 15 of each of the statistical multiplexing units 1₁-1ₙ adjusts the amount of codes of the respective encoders 11₁-11ₘ in accordance with the allocated bandwidth information to change the output bit rate. As a result, the total output multiplexed data from the multiplexing unit 2 has a bit rate that leaves no unused bandwidth within the bandwidth of the transmission line. It is also possible to provide video images of uniform and improved quality between the statistical multiplexing units.

In the aforementioned embodiment, when the multiplexed data is a transport stream (TS) of data according to the MPEG-2 scheme, a bit rate for each TS packet can be assigned to each of the statistical multiplexing units 1₁-1ₙ using the allocated bandwidth information. The statistical multiplexing status information from each of the statistical multiplexing units 1₁-1ₙ to the multiplexing unit 2 can also include at least either the amount of data in the output buffer of the statistical multiplexing unit or time information.

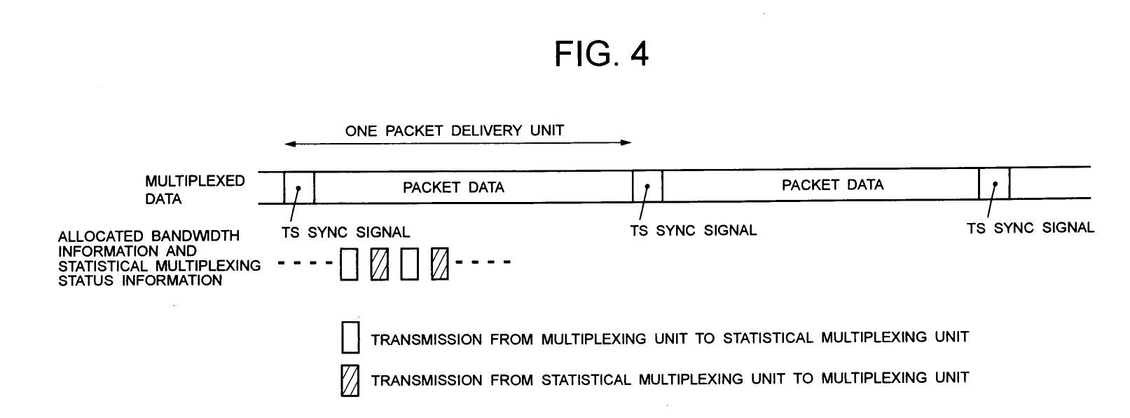

As shown in FIG. 4, bit rates can be assigned to each TS packet in synchronization with a TS sync signal. In FIG. 4, the statistical multiplexing status information and the allocated bandwidth information are communicated on the same transmission line between each of the plurality of statistical multiplexing units 1₁-1ₙ and the multiplexing unit 2. In this case, a transmission from the multiplexing unit 2 to one of the statistical multiplexing units 1₁-1ₙ or to all the statistical multiplexing units and a transmission from one of the statistical multiplexing units to the multiplexing unit 2 are performed alternately.

The TS-packet assignment information as the allocated bandwidth information is delivered to any one of the plurality of statistical multiplexing units 1₁-1ₙ from the multiplexing unit 2 with the timing determined for each of the TS packet which has been previously transmitted. The one statistical multiplexing unit sends an acknowledgement to the multiplexing unit 2 if there is a packet to be sent with the assigned timing or sends a negative acknowledgement thereto if there is no packet to be sent.

Upon reception of such an acknowledgement, the multiplexing unit 2 sends information available to determine that no change has been made in the bandwidth assignment to the statistical multiplexing units other than the one statistical multiplexing unit. On the other hand, upon reception of the negative acknowledgement, the multiplexing unit 2 reassigns the bandwidth to any one of the statistical multiplexing units which is most in need for it in consideration of the output buffer status of the statistical multiplexing units other than the one statistical multiplexing unit.

According to this method, each of the statistical multiplexing units delivers TS packets on the same clock and with the same synchronization timing. Only a TS packet delivered by one statistical multiplexing unit is effective with the timing with which the TS packet is transmitted, thus simply allowing the multiplexing unit to multiplex only the effective packet. In addition, it is possible to provide an efficient packet-by-packet delivery.

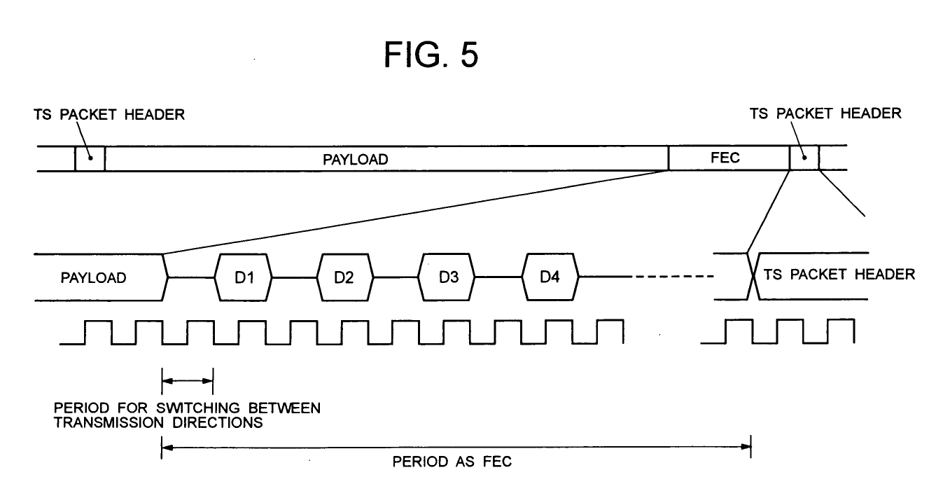

Not only the statistical multiplexing status information and the allocated bandwidth information but also the multiplexed data can be transmitted on the same transmission line between each of the plurality of statistical multiplexing units 1₁-1ₙ the multiplexing unit 2. For example, as shown in FIG. 5, the statistical multiplexing status information or the allocated bandwidth information can be transmitted in synchronization with a timing signal during an FEC (Forward Error Correction) period between the period for transmission of payload (multiplexed data) and the TS sync signal. In FIG. 5, periods D1, D2, D3, D4, . . . , are used to transmit the statistical multiplexing status information or the allocated bandwidth information, and the transmission directions are switched during periods between these information transmission periods.

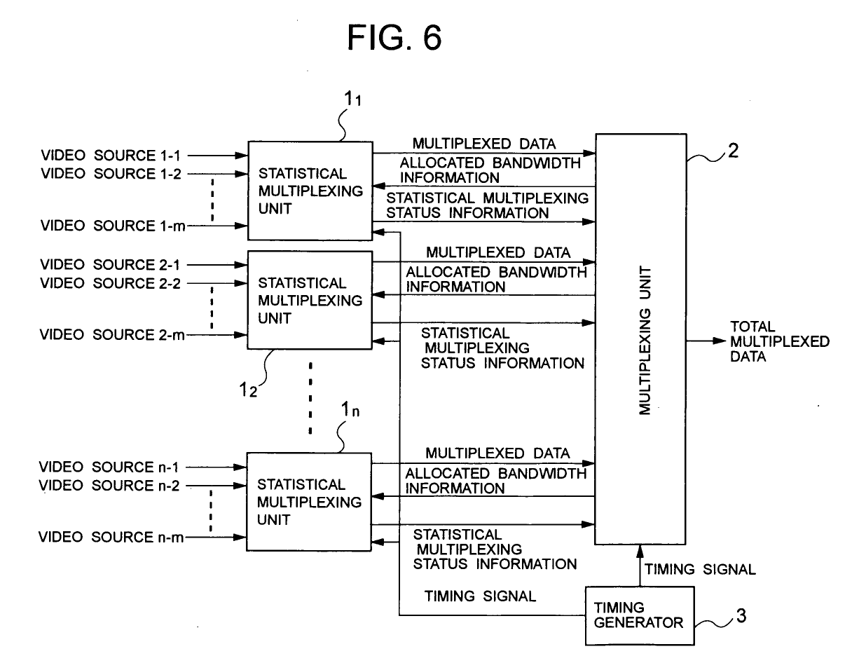

FIG. 6 shows another embodiment of the present invention. A multi-channel statistical multiplexing system of FIG. 6 is especially provided with a timing generator 3 in addition to the plurality of statistical multiplexing units 1₁-1ₙ and the multiplexing unit 2.

The timing generator 3 generates a timing signal for allowing the plurality of statistical multiplexing units 1₁-1ₙ and the multiplexing unit 2 to operate in synchronization with each other.

Each of the plurality of statistical multiplexing units 1₁-1ₙ updates the statistical multiplexing status information in synchroniation with the timing signal. The multiplexing unit 2 reads the statistical multiplexing status information form each of the plurality of statistical multiplexing units 1₁-1ₙ at the time intervals corresponding to the timing signal to perform the aforementioned bit rate setting operation. The other configuration is the same as that of the system shown in FIG. 1.

The multi-channel multiplexing system of FIG. 6 provides the statistical multiplexing status information in synchronization with the timing signal at the same point in time for each of the statistical multiplexing units 1₁-1ₙ, thereby making it possible to provide improved control to the bit rate setting operation.

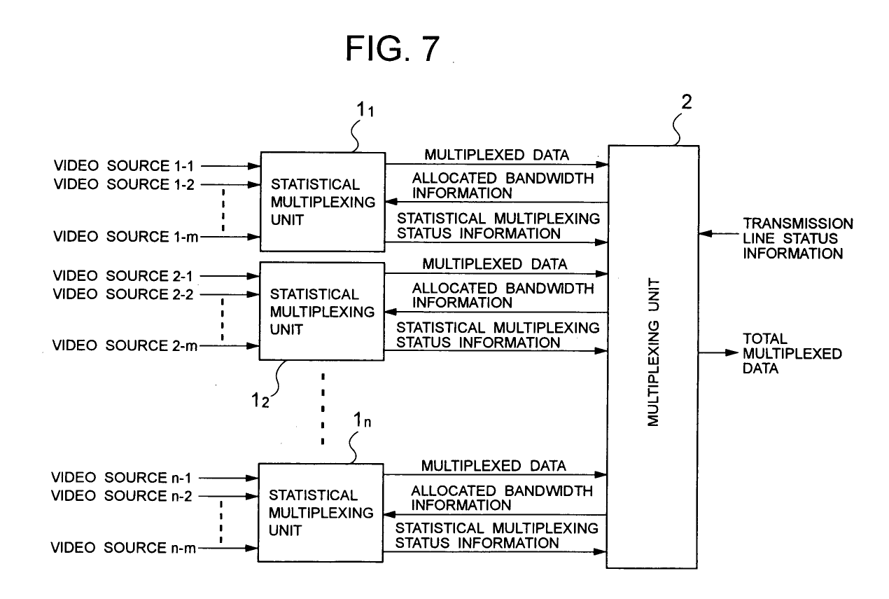

FIG. 7 shows still another embodiment of the present invention. The multi-channel statistical multiplexing system of FIG. 7 employs transmission line status detection means (not shown) to supply transmission line status information to the multiplexing unit 2. The transmission line status information indicates the status of the transmission line for use with transmission of total multiplexed data, such as its current transmission capacity. As described above, the multiplexing unit 2 assigns a reference bit rate to each of the statistical multiplexing units 1₁-1ₙ. The multiplexing unit accepts the transmission line status information to increase or decrease the bandwidth (bit rate) allocated to each of the statistical multiplexing units 1₁-1ₙ in accordance with the transmission line status information.

For example, when the transmission line status is so bad that the multiplexing unit 2 is unable to provide outputs at the predetermined bit rate, the bandwidth assigned to each of the statistical multiplexing units 1₁-1ₙ is decreased through any one of or a combination of:
(1) a priority of each of the statistical multiplexing units,
(2) an output buffer status of each of the statistical multiplexing units, and
(3) the same proportion or a given value.

On the other hand, when the transmission line status is good so that the multiplexing unit 2 can provide outputs at the predetermined bit rate, the bandwidth assigned to each of the statistical multiplexing units 1₁-1ₙ is increased through any one of or a combination of:
(1) a priority of each of the statistical multiplexing units,
(2) an output buffer status of each of the statistical multiplexing units, and
(3) the same proportion or a given value.

The multi-channel statistical multiplexing system of FIG. 7 makes it possible to efficiently deliver streams of video data without any interruption even in the presence of variations in bandwidth available for use with the transmission line.

The aforemention embodiments employ the MPEG-2 scheme as an encoding method; however, it is also possible to utilize a method according to an ITU-T (International Telecommunication Union—Telecommunication Standardization sector) recommendation H.264, or “Advanced video coding for generic audiovisual services.”

As described above, the present invention provides a multi-channel statistical multiplexing system which includes a plurality of statistical multiplexing units each for encoding a plurality of channels of video data and the multiplexing the encoded data to generate multiplexed data, and a multiplexing unit for further multiplexing the multiplexed data from the plurality of statistical multiplexing units. The system enables efficient multiplexing of multiple channels of video streams without making the configuration of the system complicated.

This application is based on a Japanese Application No. 2003-384834 which is hereby incorporated by reference.

1. A multi-channel statistical multiplexing system comprising:
a plurality of statistical multiplexing units each of which encodes a plurality of channels of video data and then multiplexes the encoded data to generate multiplexed data; and
a multiplexing unit which further multiplexes the multiplexed data from the plurality of statistical multiplexing units.

2. The multi-channel statistical multiplexing system according to claim 1, wherein
each of the plurality of statistical multiplexing units supplies statistical multiplexing status information indicative of its own operational status to the multiplexing unit and generates the multiplexed data at an assigned bit rate indicated by allocated bandwidth information supplied by the multiplexing unit, and
the multiplexing unit supplies initially the allocated bandwidth information indicative of a reference bit rate to each of the plurality of statistical multiplexing units, changes, in accordance with the statistical multiplexing status information from the one of the plurality of statistical multiplexing units, the reference bit rate of at least the one statistical multiplexing unit, and supplies allocated bandwidth information indicative of a changed bit rate to at least the one statistical multiplexing unit.

3. The multi-channel statistical multiplexing system according to claim 2, wherein
the statistical multiplexing status information includes an effective output rate and an amount of data in an output buffer of each of the plurality of statistical multiplexing units.

4. The multi-channel statistical multiplexing system according to claim 2, wherein
the multiplexed data, the allocated bandwidth information, and the statistical multiplexing status information are transmitted in synchronization with a predetermined timing signal between each of the plurality of statistical multiplexing units and the multiplexing unit.

5. The multi-channel statistical multiplexing system according to claim 2, wherein
the multiplexed data is transmitted as packet data, and
the predetermined timing signal is a synchronization signal for the packet data.

6. The multi-channel statistical multiplexing system according to claim 2, wherein
the multiplexing unit generates the allocated bandwidth information on each of the one statistical multiplexing unit and the statistical multiplexing unit having a large amount of data in the output buffer so as to
decrease the bit rate assigned to the one statistical multiplexing unit by a given rate with respect to the reference bit rate, and increase a bit rate assigned to a statistical multiplexing unit of the plurality of statistical multiplexing units, the statistical multiplexing unit having a large amount of data in an output buffer, by the given rate with respect to the reference bit rate, when it is determined that an effective output rate of the one statistical multiplexing unit is lower than the reference bit rate and an amount of data in an output buffer is less than a reference level in accordance with the statistical multiplexing status information transmitted from the one statistical multipexing unit, and
set the bit rate assigned to each of the one statistical multiplexing unit and the statistical multiplexing unit having a large amount of data in the output buffer back to the reference bit rate when the amount of data in the output buffer of the one statistical multiplexing unit has thereafter exceeded the reference level.

7. The multi-channel statistical multiplexing system according to claim 2, wherein
the allocated bandwidth information and the statistical multiplexing status information are transmitted bi-directionally on the same transmission line between each of the plurality of statistically multiplexing units and the multiplexing unit.

8. A multi-channel statistical multiplexing method comprising:
a plurality of statistical multiplexing steps each for encoding a plurality of channels of video data and then multiplexing the encoded data to generate multiplexed data; and
a multiplexing step for further multiplexing the multiplexed data generated through the plurality of statistical multiplexing steps.
